(19) United States
(12) Patent Application Publication
(10) Pub. No.: US 2026/0328702 A1
(43) Pub. Date: Oct. 22, 2026

(54) APPARATUS AND METHOD FOR ANALYSING PLASTIC CAPS

(71) Applicant: SACMI COOPERATIVA MECCANICI IMOLA SOCIETA' COOPERATIVA, IMOLA (BOLOGNA) (IT)

(72) Inventors: MANUEL GIORGI, IMOLA (BOLOGNA) (IT); MASSIMO BALDUCCI, IMOLA (BOLOGNA) (IT); MASSIMO ZOLI, IMOLA (BOLOGNA) (IT); FABRIZIO VILLA, IMOLA (BOLOGNA) (IT)

(21) Appl. No.: 19/491,151

(22) PCT Filed: Jun. 6, 2024
(86) PCT No.: PCT/IB2024/055522

§ 371 Date: Dec. 8, 2025

(30) Foreign Application Priority Data
Jun. 9, 2023 (IT) 102023000011886

(51) Int. Cl. G01N 21/90; G01N 21/88

(52) U.S. Cl. CPC G01N 21/909; G01N 21/8806

(57) ABSTRACT

An apparatus for analysing plastic caps, in which the caps extend around respective longitudinal axes and are provided with marks and with cuts, the cuts being on a lateral surface of the cap, the apparatus includes: a conveyor; an upper camera; an upper illuminator; a plurality of lateral cameras; a lateral illuminator; a control unit configured to activate the upper illuminator and the lateral illuminator sequentially and selectively, so that, at a first instant, the lateral illuminator is on and the upper illuminator is off, and at a second instant, the upper illuminator is on and the lateral illuminator is off, to command the lateral cameras to take a first image at the first instant and the upper camera to take a second image at the second instant, and to process the first and second images to verify a relative angular position between the cuts and their respective marks. The first instant precedes the second instant, or vice versa.

### TECHNICAL FIELD

This invention relates to an apparatus and a method for analysing plastic caps, in which the caps extend around respective longitudinal axes and are provided with cuts, made on a lateral surface of the cap, and with marks.

### BACKGROUND ART

This invention addresses the technical field of optical inspection systems applied to bottling machinery, with reference in particular to the inspection of caps, in particular, the inspection of a relative angular position between the cuts and the respective marks on the cap.

Typically, caps comprise a body and a tamper evident ring and the body is connected to the tamper evident ring by a connecting tear strip; more specifically, when a user twists the cap for the first time, the body is separated from the tamper evident ring and the tamper evident ring remains attached to the neck of the container. In other types of caps such as, for example, those known as “tethered caps”, a permanent connecting zone of the tear strip does not tear and keeps the cap body attached to the tamper evident ring; tethered caps are thus prevented from being lost and help reduce littering.

In both traditional caps and tethered caps, the connecting strip may include a series of cuts, or slits, and bridges, that is to say, tearable connecting zones between the body and the tamper evident ring; alternatively, especially in the case of tethered caps, the connecting strip may include recesses, that is, narrow thickness portions which are thinner than the body and the tamper evident ring and which tear when the cap is twisted for the first time.

These cuts or the narrow thickness zones may be made during a step of moulding the cap (by compression, injection or both injection and compression), for example, inside the mould itself or by using movable drawers in the mould, or during a step subsequent to moulding, for example by slitting the cap using specific knives or by a material-removal process.

In this context, patent WO2022175824 provides a cutting machine.

In this field, therefore, it is important to inspect the cuts to ensure that they have been made correctly. Inspection systems known in this field, used for detecting defects in the caps, view the caps from the outside to inspect the outside walls of the caps or they view the caps from above. Patent document 102020000012214 in the name of the present Applicant provides an apparatus and a method for inspecting a cap.

Typically in this field, to ensure that the cuts are made precisely, the caps have indicators or marks applied on them. These marks are usually on the bottom of the cap or inside it. The cuts may be made in different forms, for example, horizontal or vertical. The marks are used as references to identify the absolute position for positioning the blades that make the cuts.

To obtain correct cuts, the marks should be aligned with the blades that make the cuts.

In this field, the inspections must be performed downstream of the cutting machine to check that the machine makes the cuts or recesses at the right position (that is to say, that the cuts are aligned with the marks) so as to allow correct opening.

Patent document JPH09169392A discloses an inspection device for a beverage manufacturing process in which a beverage is filled into a light-transmitting container using a beverage filling machine, and then a cap is applied to the mouth of the container using a capping machine to keep the inside of the container airtight, and that simultaneously performs capping condition inspections following the capping process, such as whether or not the cap is missing, or the depth or inclination of the cap, and capping inspections such as label inspection on the cap to determine the type of cap, and label inspections such as determining the type of label affixed to the body of the container and inspecting for misalignment of the label affixed. The device describes by this document comprises a laser light irradiation source disposed in a position capable of irradiating a red laser light from the shoulder of the container at the lower end of the cap to the underside of the top of the cap within a vertical cross section passing substantially through the central axis of the beverage filled container, to illuminate the body of the cap from the inside, and a color imaging device for laser light disposed substantially opposite the laser light irradiation source toward the body of the cap, a light source that irradiates light of a color other than red toward the body of the cap, and a color imaging device for light source disposed opposite the light source with the cap in between. However, the solution of JPH09169392A is only capable of inspecting if the capping process has been performed correctly but does not provide any solution for verifying a correct position of the cuts.

### DISCLOSURE OF THE INVENTION

This disclosure has for an aim to overcome the above mentioned drawbacks of the prior art by providing an apparatus and a method for analysing plastic caps provided with cuts, made on a lateral surface of each cap, and with marks.

In particular, the aim of this disclosure is to provide an apparatus and a method for analysing plastic caps provided with cuts, made on a lateral surface of each cap, and with marks, where the apparatus and method are particularly efficient and precise so as to allow analysing caps with different types of cuts made on them.

This aim is fully achieved by the apparatus and method of this disclosure as characterized in the appended claims.

According to an aspect of it, this disclosure provides an apparatus for analysing plastic caps provided with marks and cuts. The cuts are made on a lateral surface of the cap. The caps extend around respective longitudinal axes. The apparatus comprises a conveyor. The conveyor is configured to transport the cap along a path. The conveyor transports the cap to a first inspection position. At the inspection position, the longitudinal axis of the cap is aligned with a first inspection axis. The conveyor also transports the cap to a second inspection position. At the second inspection position, the longitudinal axis of the cap is aligned with a second inspection axis.

The apparatus for analysing plastic caps (or apparatus, for short) includes an upper camera. The upper camera is configured to view the cap at the first inspection position from above. In particular, the upper camera views the cap at the first inspection position from above according to an optical path oriented along the first inspection axis. The apparatus includes an upper illuminator. The upper illuminator is configured to illuminate the cap located at the first inspection position from above. The illuminator illuminates the cap from above with a beam of light directed along the first inspection axis. The apparatus also includes a plurality of lateral cameras.

The lateral cameras of the plurality of lateral cameras are arranged laterally to the second inspection axis. The lateral cameras are spaced angularly from each other around the second inspection axis. The lateral cameras are oriented transversally to the second inspection axis towards it. The lateral cameras are used to view the cap located at the second inspection position from the side.

The apparatus also includes a lateral illuminator. The lateral illuminator is configured to illuminate the lateral surface of the cap positioned at the second inspection position.

The apparatus also includes a control unit. The control unit is configured to activate the upper illuminator and the lateral illuminator sequentially and selectively. In particular, the control unit is configured to activate the upper illuminator and the lateral illuminator sequentially and selectively, so that, at a first instant, the lateral illuminator is on, and the upper illuminator is off, and at a second instant, the upper illuminator is on and the lateral illuminator is off. The control unit is configured to command the lateral cameras to take a first image at the first instant. The control unit is configured to command the upper camera to take a second image at the second instant. In an example, the first instant precedes the second instant. In another example, the second instant precedes the first instant.

The control unit is configured to process the first and second images to verify a relative angular position between the cuts and their respective marks.

Thus, according to an aspect of this disclosure, the illuminators and the cameras are activated sequentially and at two different instants. This solution allows analysing the caps uninterruptedly and without stopping the conveyor; it is therefore possible to obtain a particularly efficient apparatus. Moreover, the lateral cameras and the upper camera allow providing images of the cap from different angles; by integrating and analysing these images, any type of cut can be inspected; it is therefore possible to obtain a particularly efficient apparatus.

In an example, the control unit is programmed to set a predetermined time interval between the first instant and the second instant. This solution allows illuminating the caps and capturing the images with precision.

In an example, the conveyor is configured to transport the caps along the path individually. Along the path, the caps are also spaced from each other by a predetermined distance.

In an example, the apparatus comprises a position sensor. The position sensor is configured to detect a position signal representative of a positioning of the cap at a predetermined position upstream of the first and second inspection positions. The control unit also receives the position signal. The control unit is configured to command the upper camera and the lateral cameras to capture the first and the second image based on the position signal.

Thus, the control unit may calculate the first instant and the second instant based on the position of the cap detected on the conveyor; thus, the illuminators and the cameras can be activated more precisely.

In an example, the conveyor includes a plurality of holes along it. Each hole is provided with a suction means. The holes are spaced apart from each other so that at least two holes are active on the same cap at the same time.

This solution allows keeping the cap at the same angular position along the conveyor.

In an example, the upper illuminator and the lateral illuminator comprise a strobe light. This solution allows activating the lateral illuminator and the upper illuminator at the first and second instants, respectively, one after the other without stopping the cap.

In an example, the upper camera, the upper illuminator, the plurality of lateral cameras and the lateral illuminator are positioned in an inspection station. In the inspection station, the cap may be positioned at the first and the second inspection position. In this example, the upper illuminator and the lateral illuminator are configured to illuminate an inspection volume surrounding the cap in the inspection station.

In this example, the illuminator configured to illuminate the volume of the inspection station at one between the first and the second instant preceding the other between the first and the second instant includes a strobe light.

Alternatively, the lateral illuminator and the lateral cameras may be positioned in a first inspection station. In the first inspection station, the cap is at the first inspection position. Furthermore, the upper illuminator and the upper camera may be positioned in a second inspection station.

The second inspection station is spaced from the first inspection station along the conveyor. In the second inspection station, the cap may be positioned at the second inspection position. In this example, the lateral illuminator is configured to illuminate a first inspection volume and the upper illuminator is configured to illuminate a second inspection volume, different from the first inspection volume.

It should be noted that in an example, the first inspection position might correspond to the second inspection position. In this example, the cap is stopped when it reaches the inspection position to capture the lateral-view images and the upper-view image. In this example, too, the illuminators are activated one after the other as explained above.

According to another aspect of it, this disclosure provides a method for analysing plastic caps. The caps extend around respective longitudinal axes. The caps are provided with marks. The caps are also provided with cuts made on a lateral surface of each cap. The method comprises a step of transporting the caps along a path. The caps are transported to a first inspection position. At the first inspection position, the longitudinal axis of the cap is aligned with a first inspection axis. The caps are also transported to a second inspection position. At the second inspection position, the longitudinal axis of the cap is aligned with a second inspection axis.

The method comprises a step of viewing the cap located at the first inspection position from above through an upper camera. The upper camera views the cap according to an optical path oriented along the first inspection axis.

The method comprises a step of illuminating the cap located at the first inspection position from above. The step of illuminating the cap from above is performed by an upper illuminator. The cap is illuminated from above with a beam of light directed along the first inspection axis.

The method comprises a step of viewing the cap located at the second inspection position from the side. The cap is viewed from the side by a plurality of lateral cameras. The plurality of lateral cameras are arranged laterally to the second inspection axis. The lateral cameras of the plurality of lateral cameras are spaced angularly from each other around the second inspection axis and are oriented transversely to the second inspection axis towards it.

The method comprises a step of illuminating the lateral surface of the cap, by means of a lateral illuminator.

The method comprises a step of activating the upper illuminator and the lateral illuminator sequentially and selectively, so that, at a first instant, the lateral illuminator is on and the upper illuminator is off, and at a second instant, the upper illuminator is on and the lateral illuminator is off.

The method comprises a step of commanding the lateral camera to take a first image at the first instant. The method comprises a step of commanding the upper camera to take a second image at the second instant. The first instant precedes the second instant or vice versa. The method comprises a step of processing the first and the second image to verify a relative angular position between the cuts and their respective marks.

The method may comprise a step of setting a predetermined time interval between the first instant and the second instant.

The method comprises a step of transporting the caps along a path individually. Along the path, the caps are, in particular, spaced from each other by a predetermined distance.

The method may comprise a step of detecting a position signal. The position signal is representative of a positioning of the cap at a predetermined position located upstream of the first and second inspection positions.

The method comprises a step of commanding the upper camera and the lateral cameras to capture the first and the second image based on the position signal.

In an example, the upper camera, the upper illuminator, the plurality of lateral cameras and the lateral illuminator are positioned in an inspection station. In the inspection station, the cap is at the first and the second inspection position. In an example, the upper illuminator and the lateral illuminator illuminate an inspection volume surrounding the cap in the inspection station.

In an example, the illuminator which illuminates the volume of the inspection station at one between the first and the second instant preceding the other between the first and the second instant includes a strobe light.

In an example, the lateral illuminator and the lateral cameras may be positioned in a first inspection station. In the first inspection station, the cap is at the first inspection position. Furthermore, the upper illuminator and the upper camera are positioned in a second inspection station. The second inspection station is spaced from the first inspection station along the conveyor. In the second inspection station, the cap is positioned at the second inspection position, the lateral illuminator illuminates a first inspection volume and the upper illuminator illuminates a second inspection volume, different from the first inspection volume.

In an example, a strobe light is used in the step of illuminating the cap from above and illuminating the lateral surface of the cap.

### BRIEF DESCRIPTION OF DRAWINGS

These and other features will become more apparent from the following description of a preferred embodiment, illustrated by way of non-limiting example in the accompanying drawings, in which:

FIG. 1 illustrates an apparatus for analysing plastic caps according to one or more aspects of this disclosure;

FIG. 2 shows a cross section of the apparatus;

FIG. 3 illustrates an example embodiment in which the apparatus includes two inspection stations;

FIG. 4 illustrates the lateral cameras and the upper camera of the apparatus;

FIG. 5 illustrates a cap according to one or more aspects of this disclosure;

FIGS. 6 and 7 illustrate the lateral illuminator and the upper illuminator.

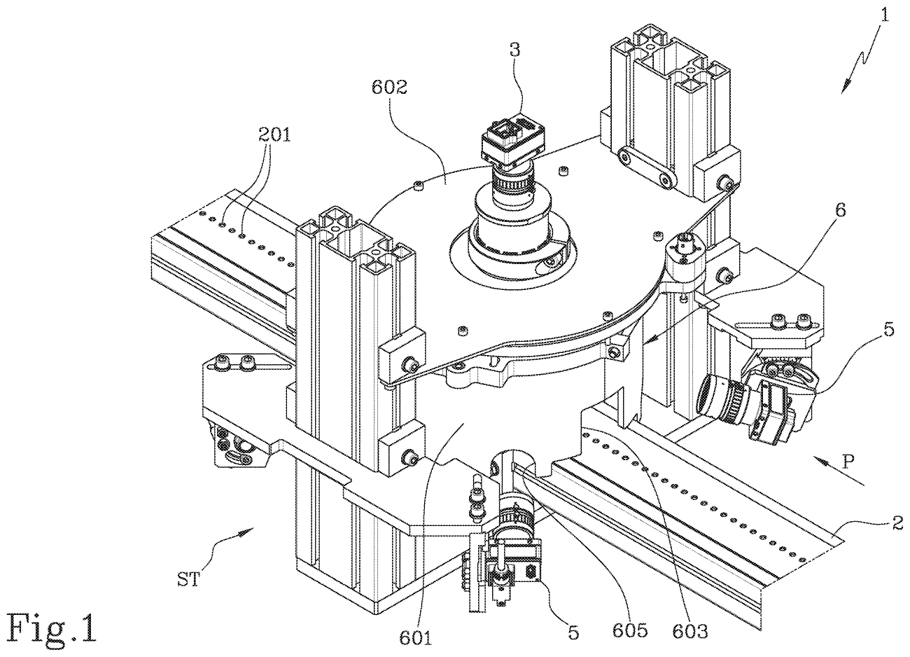

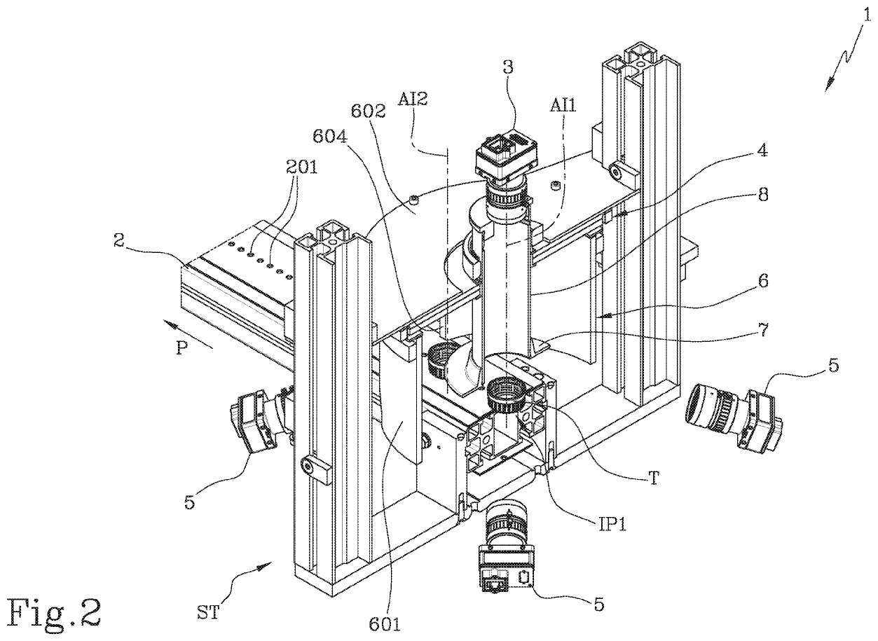

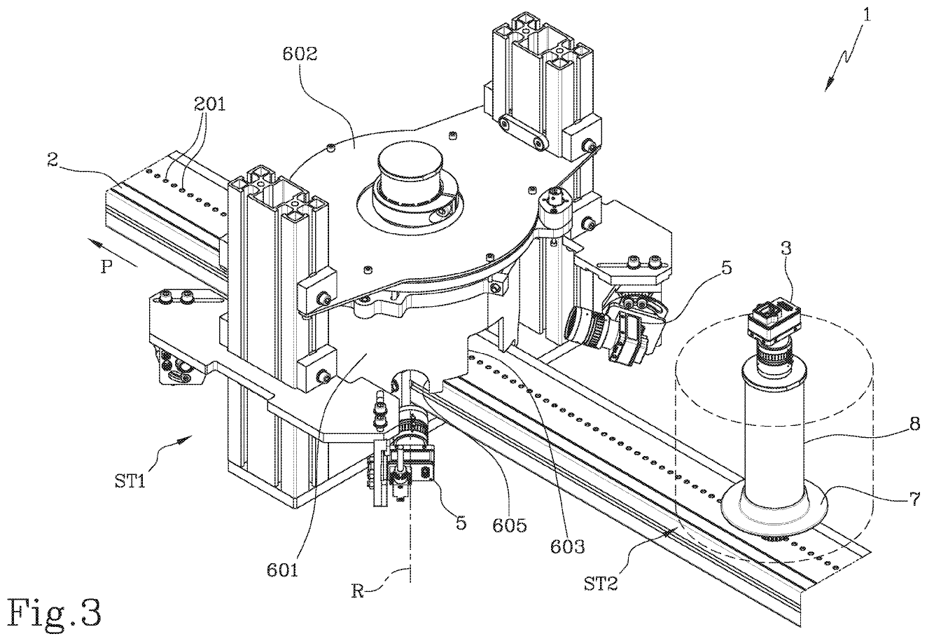

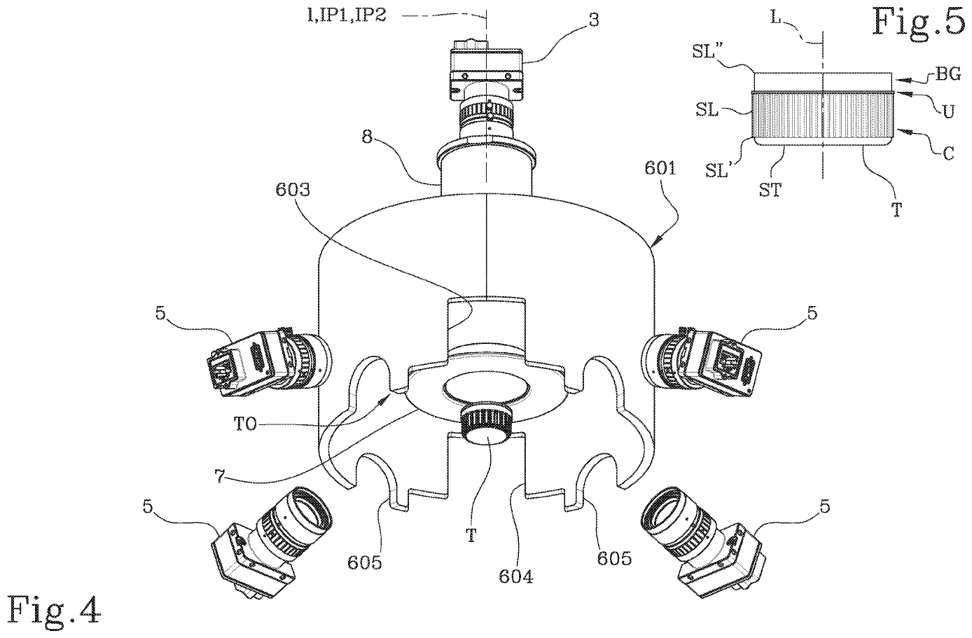

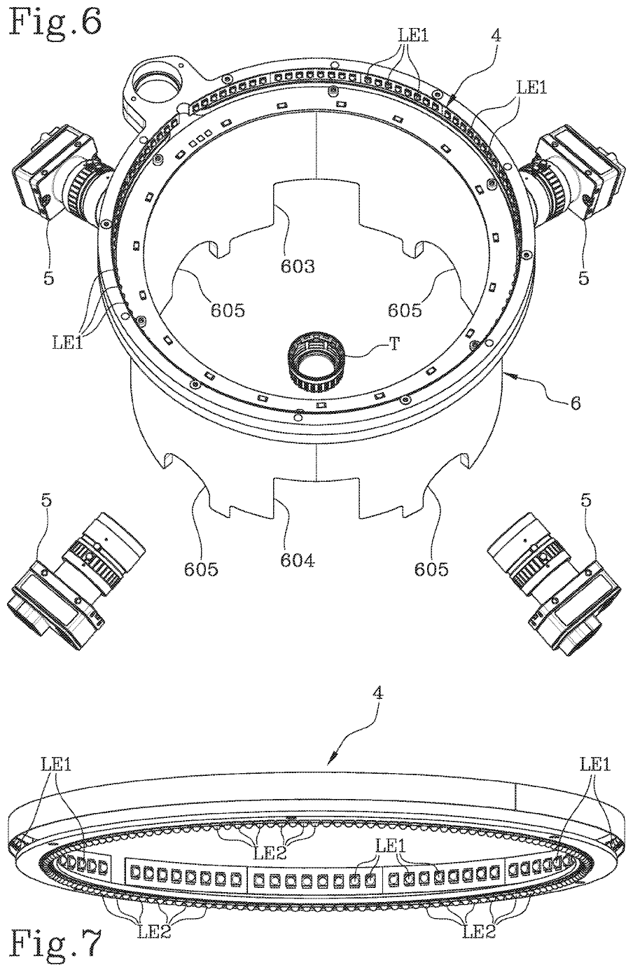

### DETAILED DESCRIPTION OF PREFERRED EMBODIMENTS OF THE INVENTION

With reference to the accompanying drawings, the numeral 1 denotes an apparatus for analysing caps, for example, plastic caps T. The plastic caps (or caps, for short) extend around respective longitudinal axes L. The caps are provided with marks and cuts. The cuts are made preferably on a lateral surface SL of the cap T. The lateral surface SL of the cap T extends around the longitudinal axis L between a first end SL′ and a second end SL″. The cap T also comprises a transverse surface ST, connected to the lateral surface SL (for example, connected to the first end of the lateral surface SL) and oriented perpendicularly to the longitudinal axis L. The marks are located on the inside surface of the cap (usually, they are located on the bottom surface of the cap; in some cases, they might also be located on the inside surface of the side wall of the cap). The lateral surface SL of the cap T comprises a joining zone U comprising the cut and/or one or a plurality of narrow thickness zones. The joining zone U defines a body C and a tamper evident strip BG of the cap T. The cut is intermittent so that the body is connected to the tamper evident strip by links, that is to say, zones of the cap that do not comprise cuts (or narrow thickness zones). The links may be temporary, that is, links configured to break when the user twists the cap T off the container for the first time; in this case, the body C and the tamper evident strip of the cap T are permanently separated. In addition, or alternatively, the links may be permanent (in which case, they may also be known as “tethers”), that is to say, links configured to allow the body to be moved away from the tamper evident strip: in this case, the body and the tamper evident strip remain attached to each other by the permanent links.

The apparatus 1 comprises a conveyor 2 for transporting the cap along a path P, including a substantially rectilinear portion. In an embodiment, the conveyor 2 is a belt. The conveyor 2 is configured to hold the cap T in place (that is, to supportably receive it) while it is being transported along the path P.

Preferably, the conveyor 2 is configured to hold the cap T on the conveyor 2 by suction. The cap T may be placed on the conveyor 2 with its transverse surface in contact with the conveyor, or with the second end of the lateral surface SL in contact with the conveyor 2. On the conveyor 2, the caps are positioned face up.

In an embodiment, the conveyor 2 comprises a feed portion, configured to receive from a feeding device an ordered succession of caps T to be inspected, where the feeding device is part of a system for the production of caps T. In an embodiment, the conveyor 2 comprises an outfeed portion configured to deliver the succession of inspected caps T to an outfeed device, where the outfeed device is part of a system for the production of caps T.

The conveyor 2 transports the cap to a first inspection position IP1, wherein the longitudinal axis L of the cap is aligned with a first inspection axis AI1. In other words, at the first inspection position IP1, the longitudinal axis L of the cap coincides with the inspection axis. The conveyor 2 also transports the cap to a second inspection position IP2, where the longitudinal axis L of the cap is aligned with a second inspection axis AI2.

In an example, the conveyor 2 is configured to transport the caps along the path individually. Along the path, the caps are spaced from each other by a predetermined distance. Furthermore, in an example, the conveyor includes a plurality of holes 201 along it. Each hole is provided with a suction means. In an example, the holes are arranged in two or more rows along the conveyor. The rows extend along the path and are parallel and spaced from each other. Furthermore, the rows (hence the holes) are spaced apart from each other so that at least two holes are active on the same cap at the same time. The conveyor may therefore be configured in such a way that the angular position of the cap along the path P remains the same. Moreover, in an inspection stretch, comprising the inspection zone (a stretch of the conveyor in which the cap is positioned at the first and the second inspection position), a zone of the conveyor in proximity to and upstream of the inspection zone, and a zone of the conveyor in proximity to and downstream of the inspection zone, the cap is held by suction through suction means with a greater intensity than in other stretches of the conveyor. This solution allows holding the cap at the same angular position while the cap is being inspected at the first and the second inspection position. Furthermore, the conveyor may be provided with a plurality of guides arranged along the inspection stretch. The guides may be wheel guides. The guides may be arranged vertically or horizontally.

The apparatus 1 comprises an upper camera 3. The upper camera 3 is configured to view the cap at the first inspection position IP1 from above.

In particular, the upper camera views the cap according to an optical path oriented along the first inspection axis AI1. Thus, the image capture axis of the upper camera corresponds to the first inspection axis. The upper camera captures an image of the inside surface of the cap.

The apparatus 1 comprises an upper illuminator 4. The upper illuminator is configured to illuminate the cap positioned at the first inspection position from above with a light beam oriented along the first inspection axis. In particular, the upper illuminator includes an illuminating ring. The illuminating ring is positioned horizontally. The ring is provided with a plurality of illuminating elements LE1 (LEDs, for example). The illuminating elements are positioned over the entire inside surface of the illuminating ring. The illuminating elements produce light beams oriented along a horizontal plane. The upper illuminator 4 includes a waveguide which conveys the light beam from the illuminating elements LE1 along the longitudinal axis (or in a direction aligned with the first inspection axis).

The first and second inspection axes are perpendicular to the path P of the conveyor 2, in particular to the rectilinear portion of the path P.

The apparatus 1 comprises a plurality of lateral cameras 5. The lateral cameras are positioned laterally to the second inspection axis AI2 and are angularly spaced from each other around the second inspection axis.

Further, the lateral cameras 5 are oriented transversely to the second inspection axis and towards it so as to view the cap at the second inspection position from the side. In particular, the images obtained by the lateral cameras are images of the lateral surface SL of the cap T at the second inspection position. Each camera 5 defines a capture axis R that is inclined relative to a plane perpendicular to the second inspection axis AI2.

The apparatus includes a lateral illuminator 6, configured to illuminate the lateral surface SL of the cap T positioned at the second inspection position.

The lateral illuminator comprises a side wall 601 extending around the second inspection axis AI2, the side wall 601 preferably having a cylindrical shape and delimiting an internal volume. The side wall preferably extends vertically from the illuminating ring.

The lateral illuminator 6 comprises a top wall 602, coupled to the side wall 601 to delimit the top of the internal volume.

The lateral illuminator 6 comprises an inlet opening 603, made in the side wall 601, to allow for passage of the cap T into the internal volume, and an outlet opening 604, to allow for passage of the cap T out of the internal volume. The side wall 601 of the illuminator comprises a plurality of openings 605 surrounding the second inspection axis. Each camera 5 is located at an opening of the plurality of openings of the side wall 601 in order to frame the lateral surface SL of the cap T. The openings 605 are preferably arc shaped.

The side wall has a tooth TO, having a first part extending horizontally and a second part which extends from the first part downwards, toward the conveyor. The first part is placed proximal to a top part of the conveyor, where the caps are placed, and the second part is placed proximal to a lateral side of the conveyor.

In particular, the conveyor 2 is configured to transport the cap T between the inlet opening 603 and the outlet opening 604 by way of the second inspection axis. It should be noted that the second inspection axis is located in the internal volume of the lateral illuminator 6.

The inspection axes define an inspection zone in which the cap T is located for inspection.

The side wall 601 of the lateral illuminator 6 comprises a diffuser body, configured to diffuse the light inside the internal volume of the lateral illuminator. The lateral illuminator 6 comprises a primary light source. The primary light source includes a plurality of lateral illuminating elements LE2, a plurality of LEDs, for example. The lateral illuminating elements LE2 produce a vertical light beam. Thus, the lateral illuminating elements may be positioned at 90° to the illuminating elements LE1 of the upper illuminator 4. Further, the illuminating elements LE1 of the upper illuminator and the lateral illuminating elements LE2 may be vertically out of alignment. The diffuser body has a ring-shaped configuration and extends along the side wall 601 of the lateral illuminator 6. The primary light source is located along an upper edge of the diffuser body so that the diffuser body diffuses the light from the primary light source in the internal volume. The lateral illuminating elements are distributed over the entire surface of the upper edge of the diffuser body. The diffuser body is preferably made from methacrylate material.

The lateral illuminator comprises a reflective layer, preferably a reflective film or a layer comprising micro cuts, configured to reflect the light. The reflective layer is located on an outside surface of the diffuser body, where the outside surface of the diffuser body is opposite to an inside surface facing towards the internal volume of the lateral illuminator. The reflective surface faces towards the internal volume to reflect the light rays directed towards the reflective layer. The reflective layer extends along the side wall of the lateral illuminator.

The lateral illuminator may comprise a collimator, configured to collimate the light emitted towards the first inspection axis. The collimator comprises a first and a second collimating filter, oriented at 90° to each other to define a collimating grid. The collimator is interposed between the second inspection axis and the diffuser body of the lateral illuminator and extends around the second inspection axis. The collimator is preferably located on the inside surface of the diffuser body so that the rays diffused by the diffuser body are collimated radially, perpendicularly to the second inspection axis.

The apparatus 1 comprises a control unit. The control unit is configured to activate the upper illuminator 4 and the lateral illuminator 6 sequentially and selectively, so that, at a first instant, the lateral illuminator is on and the upper illuminator is off, and at a second instant, the upper illuminator is on and the lateral illuminator is off. The control unit is also configured to command the lateral cameras to take a first image at the first instant and the upper camera to take a second image at the second instant. The first instant precedes the second instant or vice versa. The control unit is also programmed to process the first and second images to verify a relative angular position between the cuts and their respective marks.

Each image taken by the lateral cameras represents a respective portion of the lateral surface SL. The control unit is programmed to derive a developed image from each image taken by the lateral cameras and the upper camera, where the developed image shows the lateral surface SL of the cap T represented in a plane and illustrates the internal surface of the cap, where the marks are located. The control unit is programmed to set a predetermined time interval between the first instant and the second instant.

The apparatus 1 also comprises a position sensor is configured to detect a position signal representative of a positioning of the cap T at a predetermined position upstream of the first and second inspection positions. The control unit receives the position signal and commands the upper camera 3 and the lateral cameras 5 to capture the first and the second image based on the position signal. In particular, the speed of the conveyor is known and is entered in the control unit. Thus, based on the speed of the conveyor 2 and on the position of the cap on the conveyor 2 as detected by the position sensor, the control unit calculates the time the cap needs to reach the first and the second inspection position and, from this, obtains the first and the second instant. The position of the cap on the conveyor therefore allows deriving the instants at which the illuminators and the lateral and upper cameras must be activated. In an example, at least the illuminator that is activated first includes a strobe light. Preferably, the upper illuminator and the lateral illuminator comprise a strobe light. In a preferred embodiment, the upper camera, the upper illuminator, the plurality of lateral cameras and the lateral illuminator are positioned in an inspection station ST. In the inspection station ST, the cap is at the first and the second inspection position. In this example, the upper illuminator and the lateral illuminator are configured to illuminate an inspection volume surrounding the cap in the inspection station. In this example, therefore, the upper illuminator and the lateral illuminator are positioned in the same station and illuminate the same inspection volume. In this example, at least the illuminator that is activated first has a strobe light.

In another example, the lateral illuminator and the lateral cameras are positioned in a first inspection station ST1, where the cap is at the first inspection position, and the upper illuminator and the upper camera are positioned in a second inspection station ST2, spaced from the first inspection station along the conveyor, where the cap is positioned at the second inspection position. In this example, the lateral illuminator is configured to illuminate a first inspection volume and the upper illuminator is configured to illuminate a second inspection volume, different from the first inspection volume. In this example, therefore, the first inspection axis is not surrounded by the side wall 601.

The apparatus 1 comprises a screening element 7, located in the internal volume of the lateral illuminator, extending in a plane transverse to the second inspection axis and aligned with the second inspection axis so that the cap T, at the first and the second inspection position, is interposed between the conveyor 2 and the screening element 7.

The apparatus 1 comprises a supporting cylinder 8, inserted in a housing of the top wall and extending between a first end 4a and a second end.

The first end of the supporting cylinder is inserted in the housing of the top wall so that the supporting cylinder can slide and the second end is connected to the screening element 7. The supporting cylinder is aligned with the second inspection axis and slides along the inspection axis I to vary a distance between the screening element 7 and the cap T.

The supporting cylinder 8 may comprise an opening (for example, made in the screening element 7) and the upper camera 3 may be located at that opening. The upper camera 3 may be supported by a supporting member of the supporting cylinder. In the example in which the upper camera is positioned in the second inspection station, different from the first inspection station where the plurality of lateral cameras are positioned, the upper camera may be located at that opening in the supporting cylinder, hence surrounded by the supporting cylinder.

The apparatus 1 may comprise a locking element, configured to lock the supporting cylinder in place along the inspection axis. The locking element may include a clamp and a stop screw.

The apparatus 1 comprises a mounting assembly, configured to support the lateral illuminator. The mounting assembly comprises a mounting flange connected externally (relative to the internal volume of the lateral illuminator) to the side wall 601 of the lateral illuminator 6. The mounting assembly (specifically the mounting flange) is configured to support the plurality of cameras surrounding the second inspection axis.

The lateral illuminator 6 is configured to slide along the inspection axis, relative to the mounting flange, so as to adjust its height relative to the plurality of lateral cameras. The mounting flange is also connected to a mounting wall of the mounting assembly, surrounding the second inspection axis and located on the outside of the lateral illuminator. The mounting assembly comprises a locking element, including a mounting clamp and a mounting screw to fix the lateral illuminator in position along the second inspection axis relative to the mounting assembly.

In an embodiment, the apparatus 1 comprises a box, configured to screen the lateral illuminator from the light coming from outside the lateral illuminator. The box comprises an inlet and an outlet for the conveyor 2, located at the inlet opening and at the outlet opening of the side wall of the lateral illuminator, respectively. The box comprises a pair of handgrips.

1. An apparatus for analysing plastic caps, in which the caps extend around respective longitudinal axes and are provided with marks and with cuts, the cuts being on a lateral surface of the cap, the apparatus including:
a conveyor, configured to transport the cap along a path, to a first inspection position, in which the longitudinal axis of the cap is aligned with a first inspection axis, and to a second inspection position in which the longitudinal axis of the cap is aligned with a second inspection axis;
an upper camera, configured to view the cap located at the first inspection position from above, according to an optical path oriented along the first inspection axis;
an upper illuminator, configured to illuminate the cap positioned at the first inspection position from above with a light beam oriented along the first inspection axis;
a plurality of lateral cameras, arranged laterally to the second inspection axis, spaced angularly from each other around the second inspection axis and oriented transversely to the second inspection axis, in order to view laterally the cap arranged at the second inspection position;
a lateral illuminator configured to illuminate the lateral surface of the cap positioned at the second inspection position;
a control unit, configured
to activate the upper illuminator and the lateral illuminator sequentially and selectively, so that, at a first instant, the lateral illuminator is on, and the upper illuminator is off, and at a second instant, the upper illuminator is on and the lateral illuminator is off,
to command the lateral cameras to take a first image at the first instant and the upper camera to take a second image at the second instant, the first instant preceding the second instant or vice versa, and
to process the first and second images to verify a relative angular position between the cuts and their respective marks.

2. The apparatus according to claim 1, wherein the control unit is programmed to set a predetermined time interval between the first instant and the second instant.

3. The apparatus according to claim 1, wherein the conveyor is configured to transport the caps along the path individually, wherein the caps, along the path, are spaced apart according to a predetermined distance.

4. The apparatus according to claim 1, comprising a position sensor configured to detect a position signal representative of a positioning of the cap at a predetermined position located upstream of the first and second inspection position, in which the control unit receives the position signal and commands the upper camera and the lateral cameras to capture the first and second image based on the position signal.

5. The apparatus according to claim 1, wherein the conveyor includes a plurality of holes along the conveyor, each hole being provided with a suction means, wherein the holes are spaced apart from each other so that at least two holes are active on the same cap at the same time.

6. The apparatus according to claim 1, wherein the upper illuminator and the lateral illuminator comprise a strobe light.

7. The apparatus according to claim 1, wherein the upper camera, the upper illuminator, the plurality of lateral cameras and the lateral illuminator are positioned in an inspection station where the cap is at the first and second inspection positions, wherein the upper and the lateral illuminators are configured to illuminate an inspection volume surrounding the cap in the inspection station.

8. The apparatus according to claim 7, wherein the illuminator configured to illuminate the volume of the inspection station at one between the first and the second instant preceding the other between the first and the second instant includes a strobe light.

9. The apparatus according to claim 2, wherein the lateral illuminator and the lateral cameras are positioned in a first inspection station, where the cap is at the first inspection position, and the upper illuminator and the upper camera are positioned in a second inspection station, spaced from the first inspection station along the conveyor, where the cap is positioned at the second inspection position, wherein the lateral illuminator is configured to illuminate a first inspection volume and the upper illuminator is configured to illuminate a second inspection volume, different from the first inspection volume.

10. The apparatus according to claim 1, wherein the lateral illuminator comprises a side wall extending around the second inspection axis, and a top wall coupled to the side wall to delimit the top of an internal volume delimited by the side wall, wherein the side wall has a cylindrical shape.

11. (canceled)

12. The apparatus according to claim 10, wherein at least one of the following conditions is verified:
(i) the lateral illuminator comprises an inlet opening, made in the side wall, to allow for passage of the cap into the internal volume, and an outlet opening, to allow for passage of the cap out of the internal volume; or
(ii) the side wall of the illuminator comprises a plurality of openings surrounding the second inspection axis, wherein each camera of the plurality of lateral cameras is located at an opening of the plurality of openings of the side wall in order to frame a lateral surface of the cap.

13. (canceled)

14. The apparatus according to claim 10, wherein the side wall has a tooth, having a first part extending horizontally and a second part which extends from the first part downwards, toward the conveyor, wherein the first part is placed proximal to a top part of the conveyor, where the caps are placed, and the second part is placed proximal to a lateral side of the conveyor.

15. (canceled)

16. The apparatus according to claim 1 wherein each camera of the plurality of lateral cameras defines a capture axis that is inclined relative to a plane perpendicular to the second inspection axis.

17. A method for analysing plastic caps, in which the caps extend around respective longitudinal axes and are provided with marks and with cuts, the cuts being provided on a lateral surface of the cap, the method comprising the following steps:
transporting the caps along a path, to a first inspection position, in which the longitudinal axis of the cap is aligned with a first inspection axis, and to a second inspection position in which the longitudinal axis of the cap is aligned with a second inspection axis;
viewing the cap located at the first inspection position from above through an upper camera, according to an optical path oriented along the first inspection axis;
illuminating the cap, positioned at the first inspection position, from above by means of an upper illuminator with a beam of light directed along the first inspection axis;
viewing the cap arranged at the second inspection position, laterally, through a plurality of lateral cameras, arranged laterally to the second inspection axis, spaced angularly from each other around the second inspection axis and oriented transversally to the second inspection axis towards it;
illuminating the lateral surface of the cap, by means of a lateral illuminator;
activating the upper illuminator and the lateral illuminator sequentially and selectively, so that, at a first instant, the lateral illuminator is on and the upper illuminator is off, and at a second instant, the upper illuminator is on and the lateral illuminator is off;
commanding the lateral camera to take a first image at the first instant and the upper camera to take a second image at the second instant, the first instant preceding the second instant or vice versa,
processing the first and the second image to verify a relative angular position between the cuts and their respective marks.

18. The method according to claim 17, comprising a step of setting a predetermined time interval between the first instant and the second instant.

19. The method according to claim 17 comprising a step of transporting the caps along the path individually, in which the caps, along the path, are spaced apart according to a predetermined distance.

20. The method according to claim 17, comprising the following steps:
detecting a position signal representative of a positioning of the cap at a predetermined position located upstream of the first and second inspection positions;
commanding the upper camera and the lateral cameras to capture the first and the second image based on the position signal.

21. The method according to claim 17, wherein a strobe light is used in the step of illuminating the cap from above and illuminating the lateral surface of the cap.

22. The method according to claim 17, wherein the upper camera, the upper illuminator, the plurality of lateral cameras and the lateral illuminator are positioned in an inspection station in which the cap is at the first and at the second inspection position, wherein the upper illuminator and the lateral illuminator illuminate an inspection volume surrounding the cap in the inspection station, wherein the illuminator which illuminates the inspection station volume at one between the first and the second instant preceding the other between the first and the second instant includes a strobe light.

23. The method according to claim 17, wherein the lateral illuminator and the lateral cameras are positioned in a first inspection station, where the cap is at the first inspection position, and the upper illuminator and the upper camera are positioned in a second inspection station, spaced from the first inspection station along the conveyor, where the cap is positioned at the second inspection position, in which the lateral illuminator illuminates a first inspection volume and the upper illuminator illuminates a second inspection volume, different from the first inspection volume.
